(19) United States
(12) Patent Application Publication
(10) Pub. No.: US 2014/0288872 A1
(43) Pub. Date: Sep. 25, 2014

(54) TESTING DEVICE AND TESTING METHOD FOR TESTING PERFORMANCE PARAMETER OF ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventors: DONG-YAN LI, Shenzhen (CN); BING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., ShenZhen (CN)

(21) Appl. No.: 14/217,529

(22) Filed: Mar. 18, 2014

(30) Foreign Application Priority Data
Mar. 25, 2013 (CN) 2013100962420

(51) Int. Cl. G01N 35/00

(52) U.S. Cl. CPC G01N 35/00
USPC 702/123

(57) ABSTRACT

A testing device includes a display and a storage that stores a testing table. The testing table records at least one testing project and a test value of each of a plurality of parameters corresponding to the at least one testing project. Each parameter corresponding to a reference value range. The test value of each parameter is compared with the corresponding reference value range to determine whether the test value of each parameter is within the corresponding reference value range. The display displays test information of each test project according to a comparison result between the test value of each parameter and the corresponding value range.

### BACKGROUND

1. Technical Field

The present disclosure relates to testing technologies in relation to electronic devices, and more particularly to a testing device and method capable of automatically testing performance parameters of an electronic device.

2. Description of Related Art

During production of an electronic device, performance parameters of the electronic device are obtained to detect whether the electronic device is qualified or not. In a typical test method, a test project of the electronic device needs to be manually determined before the performance parameters corresponding to the test project are obtained. Then, the obtained parameters are manually compared with a predetermined specific value range to determine whether the parameters satisfy requirements. However, there may be a great number of test projects and performance parameters of the electronic device. Thus, the above mentioned manual method is inconvenient and wastes time.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic block diagram of an embodiment of a testing device for testing performance parameters of an electronic device.

FIG. 2 is a flowchart of an embodiment of a testing method for testing the performance parameters of the electronic device using the testing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

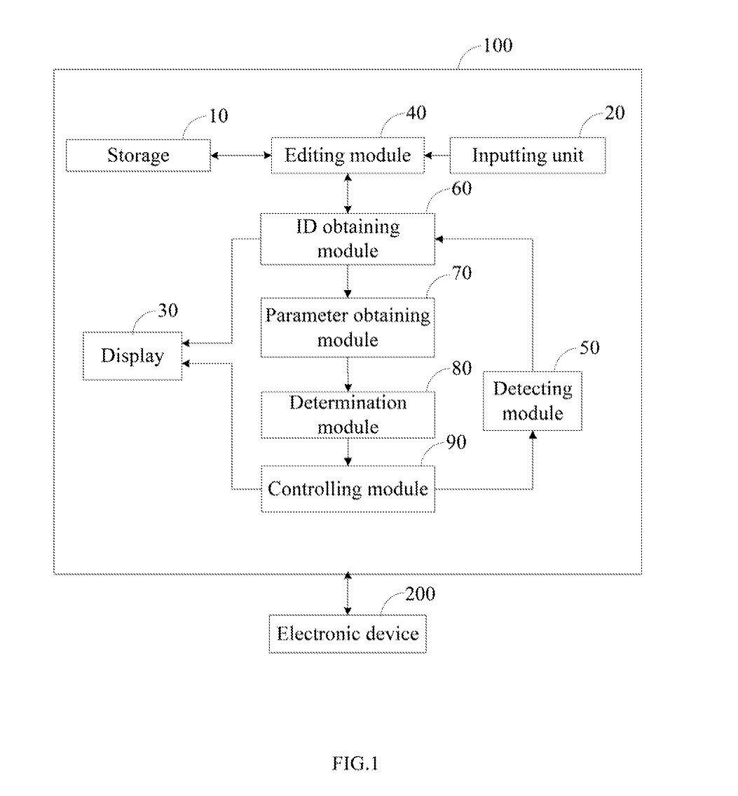

FIG. 1 shows a schematic block diagram of an embodiment of a testing device 100. The testing device 100 is configured to test performance parameters of an electronic device 200. The electronic device 100 can be a computer, or a portable DVD player, for example. The testing device 100 can be an independent device or a component integrated in the electronic device 200. In the illustrated embodiment, the electronic device is a portable digital versatile disc (DVD) player.

The electronic device 200 has a device identification (ID). The device ID can be a product serial number of the electronic device 200, or the chip barcode of the electronic device 200, for example. In this embodiment, the device ID is stored in a storage of the electronic device 200.

The testing device 100 comprises a storage 10, an inputting unit 20, a display 30, an editing module 40, a detecting module 50, an ID obtaining module 60, a parameter obtaining module 70, a determination module 80 and a controlling module 90.

The storage 10 stores a testing table. The testing table records at least one testing project and a test value of each parameter of the at least one testing project. Each parameter corresponding to a reference value range. In the present embodiment, the testing project can be a disc specification test project or a disc reading time test project. The disc specification includes size and thickness of a disc of the DVD player. The disc reading time is calculated as an average time for reading data from the innermost track of the disc to the outermost track. The test value of each parameter can be generated when the electronic device 200 executes preset program, and stored in the testing table.

The inputting unit 20 generates editing instructions in response to manual operations. The inputting unit 20 can be a keyboard, a mouse, a touch screen, a touch pad, a barcode scanner or the like.

The display 30 displays visual information. The display 30 can be an LCD display, an LED display, or other device the like.

The editing module 40 edits the test table in response to the edit instruction. For example, the editing module 40 inserts items of the test projects in the testing table, deletes items of the test projects from the testing table, and/or adjusts the order of the test projects in the test table, in response to the edit instruction.

The detecting module 50 detects whether the electronic device 200 is connected to the testing device 100. If the electronic device 200 is connected to the testing device 100, the detecting module 50 generates an obtaining instruction.

The ID obtaining module 60 obtains the device ID of the electronic device 200 from the storage of the electronic device 200. In other embodiments, the device ID can be manually inputted by a user.

The parameter obtaining module 70 obtains the test value of each parameter from the testing table. The test value of each parameter of the at least one test project recorded in the testing table can be obtained according to a predetermined order by the parameter obtaining module 70.

The determination module 80 compares the test value of each parameter with the corresponding reference value range to determine whether the test value of each parameter is within the corresponding reference value range. If the test value of each parameter of the at least one project is within the corresponding reference value range, the electronic device 200 is qualified. If the test value of at least one of the parameters is not within the corresponding reference value range, the electronic device 200 is not qualified.

The controlling module 90 controls the display 30 to display test information of each test project. When the electronic device 200 is qualified, the displayed test information includes the test value and the reference value range corresponding to each parameter of each test project, and a first prompt message indicating that the electronic device 200 is qualified. When the electronic device 200 is not qualified, the displayed information include the test value and the reference value range corresponding to each parameter of each test project, and a second prompt message indicating that the electronic device 200 is not qualified. In other embodiments, the displayed test information further includes the device ID of the electronic device 200.

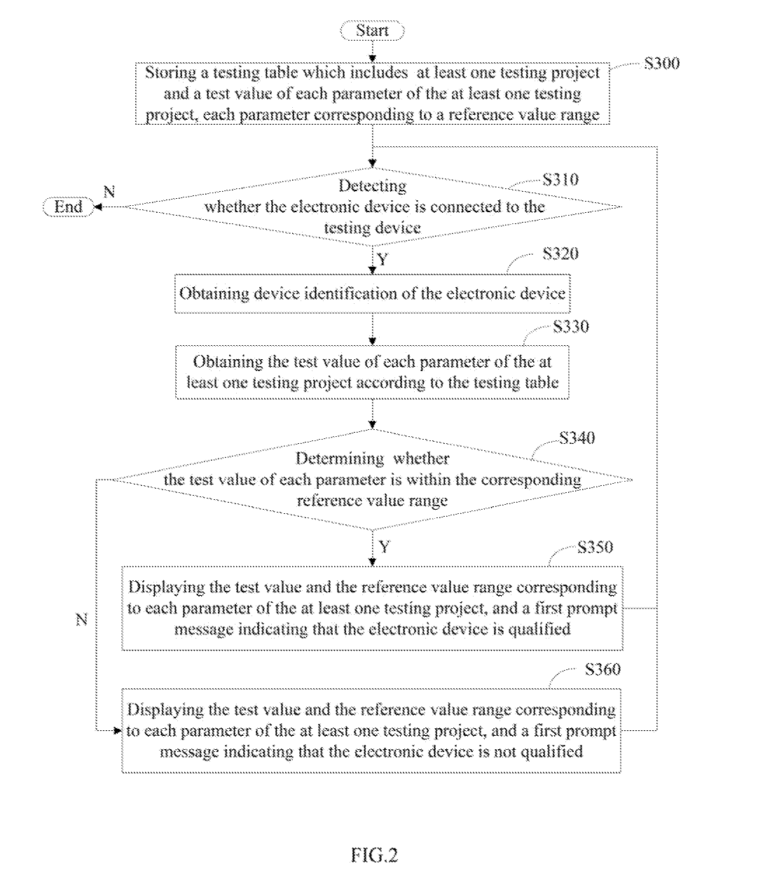

FIG. 2 shows a testing method for obtaining the performance parameters of the electronic device 200. The method is applied in the testing device 100. Depending on the embodiment, additional steps may be added, others removed, and the ordering of the steps may be changed.

In step S300, the storage 10 stores the testing table. The testing table records at least one testing project and a test value of each parameter of the at least one testing project. Each parameter corresponding to a reference value range. In the present embodiment, the testing project can be a disc specification test project or a disc reading time test project. The disc specification includes size and thickness of a disc of the DVD player. The disc reading is calculated as an average time for reading data from the innermost track of the disc to the outermost track. The test value of each parameter can be generated when electronic 200 executes preset program, and stored in the testing table.

In step S310, the detecting module 50 detects whether the electronic device 200 is connected to the testing device 100. If the electronic device 200 is connected to the testing device 100, step S320 is implemented. If no electronic device 200 is connected to the testing device 100, the process ends.

In step S320, the ID obtaining module 60 obtains the device ID of the electronic device 200 from the storage of the electronic device 200. In other embodiments, the device ID can be manually inputted by a user

In step S330, The parameter obtaining module 70 obtains the test value of each parameter from the testing table. The test value of each parameter of the at least one test project recorded in the testing table can be obtained according to a predetermined order by the parameter obtaining module 70.

In step S340, the determination module 80 compares the test value of each parameter with the corresponding reference value range to determines whether the test value of each parameter of the at least one test project is within the corresponding reference value range. If the test value of each parameter of the at least one test project is within the corresponding reference value range, step S350 is implemented. If the test value of at least one of the parameters of the at least one test project is not within the corresponding reference value range, step S360 is implemented.

In step S350, the controlling module 90 controls the display 30 to display the test value and the reference value range corresponding to each parameter of each test project, and a first prompt message indicating that the electronic device 200 is qualified.

In step S360, the controlling module 90 controls the display 30 to display the test value and the reference value range corresponding to each parameter of each test project, and a second prompt message indicating that the electronic device 200 is not qualified.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A testing device, comprising:
a display;
a storage storing a testing table, the testing table recording at least one testing project and a test value of each of a plurality of parameters corresponding to the at least one testing project, each parameter corresponding to a reference value range;
a parameter obtaining module obtaining the test value of each parameter from the testing table;
a determination module comparing the test value of each parameter with the corresponding reference value range to determine whether the test value of each parameter is within the corresponding reference value range; and
a controlling module controlling the display to display test information of each test project according to a comparison result between the test value of each parameter and the corresponding value range.

2. The testing device as claimed in claim 1, wherein when the test value of each of the parameters is within the corresponding reference value range, the testing information comprises the test value and the reference value range corresponding to each parameter of each test project, and a first prompt message indicating that the electronic device is qualified.

3. The testing device as claimed in claim 1, wherein when the test value of at least one of the parameters is not within the corresponding reference value range, the testing information comprises the test value and the reference value range corresponding to each parameter of each test project, and a second prompt message indicating that the electronic device is not qualified.

4. The testing device as claimed in claim 1, further comprising an editing module for editing the test table in response to manual operations applied to the testing device.

5. The testing device as claimed in claim 1, wherein the electronic device has a device identification (ID), the testing device further comprising an ID obtaining module for obtaining the device ID of the electronic device.

6. The testing device as claimed in claim 5, wherein the device ID is stored in the storage.

7. The testing device as claimed in claim 5, wherein the testing information comprises the device ID.

8. The testing device as claimed in claim 5, further comprising a detecting module for detecting whether the electronic device is connected to the testing device, and sending a command for controlling the ID obtaining module for obtaining the device ID of the electronic device when the electronic device is connected to the testing device.

9. A testing method applied in a testing device, the testing device comprising a display and a storage for storing a testing table, the testing table recording at least one testing project and a test value of each of a plurality of parameters corresponding to the at least one testing project, each parameter corresponding to a reference value range, the testing method comprising:
obtaining the test value of each parameter from the testing table;
comparing the test value of each parameter with the corresponding reference value range to determine whether the test value of each parameter is within the corresponding reference value range; and
controlling the display to display test information of each test project according to a comparison result between the test value of each parameter and the corresponding value range.

10. The testing method as claimed in claim 9, wherein when the test value of each of the parameters is within the corresponding reference value range, the testing information comprises the test value and the reference value range corresponding to each parameter, and a first prompt message indicating that the electronic device is qualified.

11. The testing method as claimed in claim 9, wherein when the test value of at least one of the parameters is not within the corresponding reference value range, the testing information comprises the test value of the at least one of the parameters and the reference value range corresponding to the test value of the at least one of the parameters, and a second prompt message indicating that the electronic device is not qualified.

12. The testing method as claimed in claim 9, further comprising:
editing the test table in response to manual operations applied to the testing device.

13. The testing method as claimed in claim 9, further comprising a step of obtaining a device identification (ID) of the electronic device.

14. The testing method as claimed in claim 13, wherein the device ID is stored in the storage of the electronic device.

15. The testing method as claimed in claim 13, wherein the testing information comprise the obtained device ID of the electronic device.

16. The testing method as claimed in claim 13, further comprising:
detecting whether the electronic device is connected to the testing device; and,
obtaining the device ID of the electronic device when the electronic device is connected to the testing device.
